(19) United States
(12) Patent Application Publication
(10) Pub. No.: US 2025/0368922 A1
(43) Pub. Date: Dec. 4, 2025

(54) TEXTILE WASHING METHOD

(71) Applicant: HENKEL AG & CO. KGAA, Düsseldorf (DE)

(72) Inventors: Arnd KESSLER, Monheim am Rhein (DE); Slavoljub BARACKOV, Monheim am Rhein (DE); Ingo HARDACKER, Hamminkeln (DE); Uwe SCHAUMANN, Oberderdingen (DE); Antonio DI MAGGIO, Schwaigern (DE)

(21) Appl. No.: 18/870,673

(22) PCT Filed: May 2, 2023
(86) PCT No.: PCT/EP2023/061473

§ 371 Date: Dec. 1, 2024

(30) Foreign Application Priority Data
Jun. 1, 2022 (EP) 22176779.1

(51) Int. Cl. C11D 1/83; C11D 3/30

(52) U.S. Cl. CPC C11D 1/83; C11D 3/30; C11D 2111/12; C11D 2111/40

(57) ABSTRACT

A method for washing textiles in a washing machine is described. The washing machine has a laundry treatment chamber and a storage container for storing a surfactant concentrate. The method includes providing a wash program, introducing textiles into the laundry treatment chamber of the washing machine, introducing an aqueous liquor into the laundry treatment chamber of the washing machine, diluting the surfactant concentrate which includes 50 to 95 wt. % of a surfactant and less than 10 wt. % of water, and introducing the surfactant-containing detergent composition into the laundry treatment chamber of the washing machine.

The present invention relates to a textile washing method. In particular, the application relates to a textile washing method, during which washing-active and cleaning-active substances are diluted and subsequently introduced into the laundry treatment chamber of a washing machine.

While less than one third of people in total currently have access to a textile washing machine, in some regions of the world machine textile cleaning has been the standard method for removing dirt and for refreshing laundry since the 1970s.

Over recent decades, both machine technology and the detergents used in machine-based textile cleaning methods have been continuously developed and improved in terms of their performance and their ecological footprint. While development efforts were initially focused on improving the individual components of the washing process, for example the textile washing machine and its mechanics and programs or the textile detergent, for some time now the focus of interest has also been on the consumer-friendly implementation of the machine washing method.

One development aimed at increasing operator comfort is the provision of storage and dosing devices for detergents. These devices can be affixed outside the textile washing machine or integrated therein.

European patent EP 3 305 969 B1 describes a storage container coupled to a dosing device for receiving the amount of detergent required for a plurality of cleaning programs.

European patent EP 2 478 146 B1 discloses textile washing machines having at least two dosing containers.

European patent EP 3 296 448 B1 describes a method for operating a washing machine having one or more dosing devices.

International application WO 2010/019841 A2 relates to a highly concentrated surfactant-containing detergent composition.

The means and methods for machine washing textiles hitherto known to those skilled in the art require further improvement both with regard to user comfort and with regard to the cleaning performance achieved. The object of the present application was therefore that of providing a method for machine textile cleaning which, in addition to increased comfort, also offers the consumer an improved cleaning result. Furthermore, the detergent compositions used should be characterized by reduced use of resources both with regard to the active ingredients they contain and with regard to the packaging and transport means required for their provision. Another object of this application was the provision of highly concentrated detergents for use in washing machines.

A first subject of this application is a method for washing textiles in a washing machine which has a laundry treatment chamber and a storage container for a surfactant concentrate, having the steps of
a) providing a washing machine with a wash program;
b) introducing textiles into the laundry treatment chamber of the washing machine;
c) introducing an aqueous liquor into the laundry treatment chamber of the washing machine;
d) providing a surfactant-containing detergent composition by diluting a surfactant concentrate which contains, relative to the total weight thereof,
   i) 50 to 95 wt. % surfactant;
   ii) less than 10 wt. % water;
e) introducing the surfactant-containing detergent composition into the laundry treatment chamber of the washing machine.

A motor-driven device for cleaning textiles is referred to as a washing machine. Particularly preferred are rotary washing machines with an inner tub rotatable about a horizontal axis. The method according to the invention is suitable in particular for implementation in a washing machine with an outer tub, an inner tub attached within the outer tub, as laundry treatment chamber, and a pumping device that is configured to pump aqueous liquor out of the outer tub.

In step a) of the method, a washing machine with a wash program is provided. Conventional washing machines usually have a plurality of wash programs provided for cleaning different textiles, which wash programs can have, in addition to a main wash cycle, pre-rinse, rinse and/or spin cycles. Preferred wash programs comprise a main wash cycle, at least one rinse cycle and at least one spin cycle. Alternative wash programs have at least one pre-wash cycle, a main wash cycle, at least one rinse cycle, and at least one spin cycle.

In addition to the mechanical forces acting on the laundry, the detergent used and the liquor temperature reached in the washing liquor, the duration of the wash cycle, in particular of the main wash cycle, has an influence on the cleaning performance achieved. The duration t_{w} of the main wash cycle used in the washing method is preferably 15 to 400 minutes, preferably 30 to 240 minutes, and in particular 60 to 180 minutes.

The textiles introduced into the laundry treatment chamber in step b) can be, for example, cotton, wool or synthetic textiles, but also mixed fabrics.

The aqueous liquor introduced into the laundry treatment chamber in step c) preferably has a volume of 8 to 40 l, particularly preferably 12 to 35 l.

The loading of the washing machine with textiles in step b) and the volume of the aqueous liquor introduced in step c) are preferably coordinated with one another in such a way that the weight ratio of aqueous liquor to textiles in step c) is above 1:1, preferably above 2:1, and in particular above 5:2.

The aqueous liquor preferably has a temperature T1 of 18 to 25° C. in step c).

The surfactant concentrate used in step d) is preferably taken from a container integrated into the washing machine, which is filled with several times the amount of surfactant concentrate required to carry out a washing program.

The surfactant concentrate contains, relative to the total weight thereof, preferably 55 to 92 wt. %, in particular 60 to 88 wt. %, and particularly preferably 68 to 80 wt. % anionic surfactant.

The group of surfactants includes the non-ionic, anionic, cationic and amphoteric surfactants. The compositions according to the invention can comprise one or more of the surfactants mentioned. Particularly preferred compositions contain surfactant from the group of anionic and non-ionic surfactants.

The anionic surfactant is preferably selected from the group comprising C₉₋₁₃ alkylbenzenesulfonic acids, olefin sulfonic acids, C₁₂₋₁₈ alkanesulfonic acids, ester sulfonic acids, alk(en)yl sulfonic acids, fatty alcohol ether sulfonic acids and mixtures thereof. Compositions which comprise C₉₋₁₃ alkylbenzenesulfonic acids and fatty alcohol ether sulfonic acids as the anionic surfactant have particularly good dispersing properties. Surfactants of the sulfonic acid type that can be used are preferably C₉₋₁₃ alkylbenzenesulfonic acids, olefin sulfonic acids, i.e., mixtures of alkene and hydroxyalkane sulfonic acids, and disulfonic acids, as obtained, for example, from C₁₂₋₁₈ monoolefins having a terminal or internal double bond by way of sulfonation with gaseous sulfur trioxide and subsequent alkaline or acid hydrolysis of the sulfonation products. C₁₂₋₁₈ alkanesulfonic acids and the esters of α-sulfofatty acids (ester sulfonic acids) are also suitable, for example the α-sulfonated methyl esters of hydrogenated coconut, palm kernel or tallow fatty acids.

In a particularly preferred washing method, the surfactant concentrate contains anionic surfactant from the group from the group of C₈₋₁₈ alkylbenzenesulfonic acids. The use of alkylbenzenesulfonic acids from the group of C₉₋₁₅ alkylbenzenesulfonic acids, in particular C₉₋₁₃ alkylbenzenesulfonic acids, is particularly preferred.

Alternatively, but preferably in combination with the alkylbenzenesulfonic acid, the surfactant concentrate comprises anionic surfactant from the group from the group of alkyl ether sulfonic acids.

Preference is given to alkyl ether sulfonic acids having the formula R₁—O-(AO)ₙ—SO₃H, wherein
R₁ represents a linear or branched, substituted or unsubstituted alkyl radical, preferably a linear, unsubstituted alkyl radical, particularly preferably a fatty alcohol radical. Preferred radicals R₁ are selected from decyl, undecyl, dodecyl, tridecyl, tetradecyl, pentadecyl, hexadecyl, heptadecyl, octadecyl, nonadecyl and eicosyl radicals and mixtures thereof, wherein the representatives having an even number of C atoms are preferred. Particularly preferred radicals R₁ are derived from fatty alcohols having 12 to 18 C atoms, for example from coconut fatty alcohol, tallow fatty alcohol, lauryl alcohol, myristyl alcohol, cetyl alcohol or stearyl alcohol, or from oxo alcohols having 10 to 20 C atoms.
AO represents an ethylene oxide (EO) or propylene oxide (PO) group, preferably an ethylene oxide group. The index n in the formula is an integer from 1 to 50, preferably from 1 to 20, and in particular from 2 to 10. Very particularly preferably, n is 2, 3, 4, 5, 6, 7 or 8.

As a further optional component which is preferably present in the surfactant concentrate in combination with the aforementioned alkylbenzenesulfonic acids and alkyl ether sulfonic acids, the surfactant concentrate contains anionic surfactant from the group from the group of fatty acids. Particularly preferred fatty acids are selected from the group of caprylic acid, capric acid, lauric acid, myristic acid, palmitic acid, stearic acid, oleic acid, linoleic acid and mixtures thereof.

Preferred surfactant concentrates used in step d) of the method contain, relative to the total weight thereof, 30 to 90 wt. %, preferably 40 to 80 wt. %, more preferably 45 to 70 wt. %, and in particular 51 to 70 wt. % anionic surfactant. The proportion by weight of the anionic surfactant is determined as the proportion by weight of the anionic surfactant acid, regardless of the degree of neutralization of the anionic surfactant in the surfactant concentrate.

Specific weight ratios of the anionic surfactants to each other have proven to be advantageous for the rheological properties and the dilution properties of the surfactant concentrate.

Preference is therefore given to washing methods in which the surfactant concentrate contains C₈₋₁₈ alkylbenzenesulfonic acid and alkyl ether sulfonic acid as anionic surfactant, the C₈₋₁₈ alkylbenzenesulfonic acid and the alkyl ether sulfonic acid being present in a weight ratio of 10:1 to 1:1, preferably 7:1 to 2:1 and in particular 5:1 to 5:2.

Preference is also given to washing methods in which the surfactant concentrate contains C₈₋₁₈ alkylbenzenesulfonic acid and fatty acid as anionic surfactant, the C₈₋₁₈ alkylbenzenesulfonic acid and the fatty acid being present in a weight ratio of 20:1 to 6:1, preferably 18:1 to 6:1 and in particular 15:1 to 8:1.

Preference is also given to washing methods in which the surfactant concentrate contains alkyl ether sulfonic acid and fatty acid as anionic surfactant, the alkyl ether sulfonic acid and the fatty acid being present in a weight ratio of 6:1 to 1:1, preferably 5:1 to 3:2 and in particular 4:1 to 2:1.

The aforementioned weight ratios are suitable for advantageously influencing the properties of the surfactant concentrate during filling and dosing but also with regard to rapid and homogeneous dilution.

As a further optional component, the surfactant concentrate contains nonionic surfactant, preferably nonionic surfactant from the group of ethoxylated primary C₆₋₁₈ alcohols, preferably the ethoxylated primary C₆₋₁₈ alcohols having a degree of alkoxylation ≥2, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO.

Preferred surfactant concentrates used in step d) of the method contain, relative to the total weight thereof, 7 to 50 wt. %, preferably 12 to 40 wt. %, and in particular 15 to 30 wt. % nonionic surfactant.

Particularly with regard to a rapid and homogeneous dilution of the surfactant concentrate, it has proven advantageous to maintain weight ratios of anionic surfactant to nonionic surfactant in the surfactant concentrate in the range from 4:1 to 1:8, preferably from 3:1 to 1:4 and in particular from 11:4 to 1:1.

A group of optional components of the surfactant concentrates is formed by the polyalkoxylated amines having a weight-average molecular weight Mw in the range from 600 g/mol to 10,000 g/mol, which are obtained by reacting ammonia or primary alkylamines or hydroxyalkylamines having a molecular weight of less than 200 g/mol with alkylene oxides. The proportion by weight of these polyalkoxylated amines with respect to the total weight of the surfactant concentrate is preferably 0.5 to 10 wt. %, particularly preferably 1 to 8 wt. % and in particular 2 to 6 wt. %.

Preferred polyalkoxylated amines have a weight-average molecular weight M_{w} in the range from 1300 g/mol to 6000 g/mol, in particular from 1400 g/mol to 4500 g/mol. (The average molecular weights indicated here, and later optionally for other polymers, are weight-average molecular weights M_{w} which can in principle be determined by means of gel permeation chromatography with the aid of an RI detector, the measurement expediently being carried out against an external standard.) For their preparation, it is possible to start, in a known manner, from ammonia, a monoalkylamine, a monoalkyl-monoalkanolamine or a monoalkyl-dialkanolamine or a mono-, di- or trialkanolamine, for example triethanolamine, methyl-, ethyl-, propyl- and isopropyl-diethanolamine, methyl-, ethyl-, propyl- and isopropyl-diisopropanolamine, tripropanolamine, triisopropanolamine, N,N-Di-(2-hydroxyethyl)cyclohexylamine, N,N-Di-(2-hydroxypropyl)cyclohexylamine, n-butylamine, n-hexylamine, n-octylamine, isopropylamine, sec-butylamine, tert-butylamine, cyclohexylamine, 2-ethylhexylamine, 2-phenylethylamine and mixtures thereof, which is reacted with an alkylene oxide, in particular selected from the group consisting of ethylene oxide, propylene oxide, butylene oxide and mixtures thereof, in particular with a mixture containing propylene oxide and preferably ethylene oxide, particularly preferably with propylene oxide. The polyalkoxylated amines thus obtained may be block or random structures. Particular preference is given, inter alia, to a polyalkoxylated amine obtained by propoxylation of triethanolamine, preferably having a length of the three side arms of 15 propylene oxide units in each case. Also preferred is a polyalkoxylated amine obtainable by propoxylation of triisopropanolamine, preferably having a length of the three side arms of 15 propylene oxide units in each case. Polyalkoxylated monoalkylamines having a linear, branched or cyclic alkyl group are likewise suitable, an alkylene oxide selected from the group consisting of ethylene oxide, propylene oxide, butylene oxide and mixtures thereof being alkoxylated, preferably with a mixture comprising propylene oxide, more preferably with propylene oxide. Preference is also given to a polyalkoxylated amine obtained by propoxylation of tert-butylamine, preferably having a length of the two side arms of 12 propylene oxide units in each case.

Preferred polyalkoxylated amines satisfy the general formula

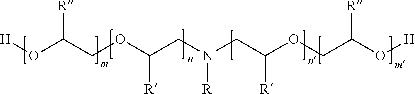

in which R represents a linear, optionally branched or optionally cyclic alkyl group having 1 to 12 C atoms or a —(CH₂CHR′O)_{n″}—(CH₂CHR″O)_{m″}—H group,
R′ and R″, independently of one another, represent H, CH₃ or CH₂CH₃,
n, n′ and n″, independently of one another, represent numbers from 0 to 30, preferably from 0 to 10 and in particular 0 to 5, and
m, m′ and m″, independently of one another, represent numbers from 0 to 30, preferably from 5 to 20 and in particular from 12 to 16,
with the proviso that the sum n+n′+n″+m+m′+m″ is at least 14, preferably in the range of from 18 to 100 and in particular in the range of from 20 to 70. Preferably, in the compounds of the formula I, at least one of the functional groups R′ and R″ is a CH₃ group.

As a further optional component, the surfactant concentrate contains a polyalkoxylated polyalkyleneimine, which can be obtained by reacting polyalkyleneimines with alkylene oxides, with proportions by weight relative to the total weight of the surfactant concentrate of 0.5 to 10 wt. %, preferably 1 to 8 wt. % and in particular 2 to 6 wt. % being preferred.

The polyalkoxylated polyalkyleneimine is a polymer having a polyalkyleneimine backbone which carries polyalkoxy groups on the N atoms. It preferably has a weight-average molecular weight Mw in the range from 5000 g/mol to 60000 g/mol, in particular from 10000 g/mol to 22500 g/mol. The polyalkyleneimine has primary amino functions at the ends and preferably both secondary and tertiary amino functions in the interior, and optionally it can also have only secondary amino functions in the interior, such that the result is not a branched-chain but a linear polyalkyleneimine. The ratio of primary to secondary amino groups in the polyalkyleneimine is preferably in the range from 1:0.5 to 1:1.5, in particular in the range from 1:0.7 to 1:1. The ratio of primary to tertiary amino groups in the polyalkyleneimine is preferably in the range from 1:0.2 to 1:1, in particular in the range from 1:0.5 to 1:0.8. The polyalkylene imine preferably has a weight-average molecular weight in the range from 500 g/mol to 50000 g/mol, in particular from 550 g/mol to 2000 g/mol. The N atoms in the polyalkyleneimine are preferably separated from one another by alkylene groups having 2 to 12 C atoms, in particular 2 to 6 C atoms, although it is not necessary for all the alkylene groups to have the same number of C atoms. Ethylene groups, 1,2-propylene groups, 1,3-propylene groups and mixtures thereof are particularly preferred. The primary amino functions in the polyalkyleneimine can carry 1 or 2 polyalkoxy groups and the secondary amino functions can carry 1 polyalkoxy group, not every amino function having to be alkoxy group-substituted. The average number of alkoxy groups per primary and secondary amino function in the polyalkoxylated polyalkylenimine is preferably 5 to 100, in particular 10 to 50. The alkoxy groups in the polyalkoxylated polyalkylene imine are preferably ethoxy, propoxy or butoxy groups or mixtures thereof. Polyethoxylated polyethyleneimines are particularly preferred. The polyalkoxylated polyalkyleneimines are obtainable by reacting the polyalkyleneimines with epoxides corresponding to the alkoxy groups. If desired, the terminal OH function of at least some of the polyalkoxy substituents can be replaced by an alkyl ether function having 1 to 10, in particular 1 to 3, C atoms.

Preferred surfactant concentrates contain, relative to the total weight thereof, 12 to 36 wt. %, preferably 18 to 34 wt. %, and in particular 24 to 32 wt. %, solvent. As stated at the outset, surfactant concentrates with the lowest possible proportion of inactive ingredients are used for use in the washing method according to the invention. Since water belongs to the group of inactive ingredients, it is therefore preferred that the surfactant concentrate contains less than 10 wt. %, preferably less than 6 wt. %, and in particular less than 2 wt. %, water. As the proportion of inactive ingredients decreases, not only does the amount of resources required for packaging, storage and transport of the surfactant concentrates decrease, but at the same time the volume of surfactant concentrate used per washing method also decreases and thus the scope of a storage container, for example a storage container integrated into the washing machine, increases.

For the handleability of the surfactant concentrates, in particular for implementing the dilution in step e), a proportion by weight of 0.5 to 29 wt. %, preferably 4.5 to 27 wt. % and in particular 10 to 24 wt. % organic solvent, relative to the total weight of the surfactant concentrate, has proven to be advantageous. In a particularly preferred embodiment of the washing method, the surfactant concentrate contains, relative to the total weight thereof, 12 to 38 wt. %, preferably 15 to 35 wt. % and in particular 20 to 32 wt. %, organic solvent. Cleaning-enhancing effects in the washing method can be attributed to organic solvents. This applies in particular when using organic solvents from the group of organic amines, preferably monoethanolamine. The use of these not only has a cleaning-enhancing effect, but also enables the partial or complete neutralization of any anionic surfactant acids present in the surfactant concentrate.

In a preferred embodiment of the washing method, the surfactant concentrate comprises anionic surfactant from the group of C₈₋₁₈ alkylbenzenesulfonic acids, alkyl ether sulfonic acids and fatty acids, and also a superstoichiometric amount, relative to the anionic surfactant, of organic amine, preferably monoethanolamine. This way of proceeding makes it possible, in the course of the dilution of the surfactant concentrate, for example for neutralization reactions to be carried out in parallel with additional acids added during the dilution.

With regard to the packaging, filling, dosing, dilution and subsequent cleaning performance of the surfactant concentrate, the use of organic amines, in particular the use of monoethanolamine, has proven superior to the use of low-molecular-weight organic alcohols and ethers. For this reason, it is preferred that the surfactant concentrate contains, relative to the total weight thereof, less than 12 wt. %, preferably less than 8 wt. %, particularly preferably less than 4 wt. % and in particular less than 1 wt. % organic solvent from the group of monohydric, dihydric or trihydric alcohols having a molecular weight of 30 to 120 g/mol.

It is further preferred that the surfactant concentrate contains, relative to the total weight thereof, less than 12 wt. %, preferably less than 8 wt. %, particularly preferably less than 4 wt. % and in particular less than 1 wt. % organic solvent from the group of ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxybutanol, propylene glycol t-butylether, di-n-octylether and mixtures thereof, preferably from the group of propanediol, glycerol and mixtures thereof.

In summary, washing methods are preferred in which the surfactant concentrate in step d) contains, relative to the total weight thereof
i) 30 to 90 wt. %, preferably 40 to 80 wt. %, and in particular 45 to 70 wt. % anionic surfactant from the group of C₈₋₁₈ alkylbenzenesulfonic acids, alkyl ether sulfonic acids and fatty acids,
ii) 7 to 50 wt. %, preferably 12 to 40 wt. %, and in particular 15 to 30 wt. % nonionic surfactant from the group of ethoxylated primary C6-18 alcohols,
iii) 0.5 to 29 wt. %, preferably 4.5 to 27 wt. % and in particular 10 to 24 wt. % organic solvent from the group of organic amines,
iv) less than 10 wt. %, preferably less than 6 wt. % and in particular less than 2 wt. % water.

In particular, washing methods are preferred using a surfactant concentrate which contains, relative to the total weight thereof
i) 30 to 80 wt. %, preferably 40 to 70 wt. %, and in particular 45 to 60 wt. % anionic surfactant from the group of C₈₋₁₈ alkylbenzenesulfonic acids, alkyl ether sulfonic acids and fatty acids,
ii) 7 to 50 wt. %, preferably 12 to 40 wt. %, and in particular 15 to 30 wt. % nonionic surfactant from the group of ethoxylated primary C6-18 alcohols,
iii) 12 to 38 wt. %, preferably 15 to 35 wt. % and in particular 20 to 32 wt. % organic solvent from the group of organic amines,
iv) less than 10 wt. %, preferably less than 6 wt. % and in particular less than 2 wt. % water.

Finally, washing methods are preferred in which the surfactant concentrate contains, relative to the total weight thereof,
i) 30 to 80 wt. %, preferably 40 to 70 wt. %, and in particular 45 to 60 wt. % anionic surfactant in the form of a mixture of C₈₋₁₈ alkylbenzenesulfonic acids, alkyl ether sulfonic acids and fatty acids,
ii) 7 to 50 wt. %, preferably 12 to 40 wt. %, and in particular 15 to 30 wt. % nonionic surfactant from the group of ethoxylated primary C6-18 alcohols,
iii) 12 to 38 wt. %, preferably 15 to 35 wt. % and in particular 20 to 32 wt. % organic solvent from the group of organic amines,
iv) less than 10 wt. %, preferably less than 6 wt. % and in particular less than 2 wt. % water.

The composition of some particularly preferred surfactant concentrates used in the method can be found in the following tables (amounts given in wt. % relative to the total weight of the surfactant concentrate, unless otherwise indicated).

| | Formula 1 | Formula 2 | Formula 3 | Formula 4 |
|---|---|---|---|---|
| Total surfactant | 50 to 80 | 50 to 80 | 50 to 80 | 50 to 80 |
| Anionic surfactant | 40 to 65 | 40 to 65 | 45 to 60 | 45 to 60 |
| Non-ionic surfactant | 12 to 40 | 12 to 40 | 15 to 30 | 15 to 30 |
| Water | <10 | <6 | <6 | <2 |
| Misc. | up to 100 | up to 100 | up to 100 | up to 100 |

| | Formula 6 | Formula 7 | Formula 8 | Formula 9 |
|---|---|---|---|---|
| Total surfactant | 50 to 80 | 50 to 80 | 50 to 80 | 50 to 80 |
| Anionic surfactant | 40 to 65 | 40 to 65 | 45 to 60 | 45 to 60 |
| Non-ionic surfactant | 12 to 40 | 12 to 40 | 15 to 30 | 15 to 30 |
| Organic amine, preferably | 12 to 38 | 15 to 35 | 20 to 32 | 20 to 32 |
| monoethanolamine | | | | |
| Water | <10 | <6 | <6 | <2 |
| Misc. | up to 100 | up to 100 | up to 100 | up to 100 |
| | Formula 11 | Formula 12 | Formula 13 | Formula 14 |
| Total surfactant | 50 to 80 | 50 to 80 | 50 to 80 | 50 to 80 |
| Anionic surfactant | 40 to 65 | 40 to 65 | 45 to 60 | 45 to 60 |
| Non-ionic surfactant | 12 to 40 | 12 to 40 | 15 to 30 | 15 to 30 |
| Organic amine, preferably | 12 to 38 | 15 to 35 | 20 to 32 | 20 to 32 |
| monoethanolamine | | | | |
| Water | <10 | <6 | <6 | <2 |
| Misc. | <10 | <6 | <6 | <2 |

| | Formula 16 | Formula 17 | Formula 18 | Formula 19 |
|---|---|---|---|---|
| Total surfactant | 50 to 80 | 50 to 80 | 50 to 80 | 50 to 80 |
| Anionic surfactant | 40 to 65 | 40 to 65 | 45 to 60 | 45 to 60 |
| C₈₋₁₈ alkylbenzene- | 35 to 60 | 35 to 60 | 41 to 54 | 41 to 54 |
| sulfonic acid | | | | |
| Fatty acid | 1 to 8 | 1 to 8 | 2 to 6 | 2 to 6 |
| Non-ionic surfactant | 12 to 40 | 12 to 40 | 15 to 30 | 15 to 30 |
| Water | <10 | <6 | <6 | <2 |
| Misc. | up to 100 | up to 100 | up to 100 | up to 100 |

| | Formula 21 | Formula 22 | Formula 23 | Formula 24 |
|---|---|---|---|---|
| Total surfactant | 50 to 80 | 50 to 80 | 50 to 80 | 50 to 80 |
| Anionic surfactant | 40 to 65 | 40 to 65 | 45 to 60 | 45 to 60 |
| C₈₋₁₈ alkylbenzene- | 35 to 60 | 35 to 60 | 41 to 54 | 41 to 54 |
| sulfonic acid | | | | |
| Fatty acid | 1 to 8 | 1 to 8 | 2 to 6 | 2 to 6 |
| Non-ionic surfactant | 12 to 40 | 12 to 40 | 15 to 30 | 15 to 30 |
| Organic amine, preferably | 12 to 38 | 15 to 35 | 20 to 32 | 20 to 32 |
| monoethanolamine | | | | |
| Water | <10 | <6 | <6 | <2 |
| Misc. | up to 100 | up to 100 | up to 100 | up to 100 |
| | Formula 26 | Formula 27 | Formula 28 | Formula 29 |
| Total surfactant | 50 to 80 | 50 to 80 | 50 to 80 | 50 to 80 |
| Anionic surfactant | 40 to 65 | 40 to 65 | 45 to 60 | 45 to 60 |
| C₈₋₁₈ alkylbenzene- | 35 to 60 | 35 to 60 | 41 to 54 | 41 to 54 |
| sulfonic acid | | | | |
| Fatty acid | 1 to 8 | 1 to 8 | 2 to 6 | 2 to 6 |
| Non-ionic surfactant | 12 to 40 | 12 to 40 | 15 to 30 | 15 to 30 |
| Organic amine, preferably | 12 to 38 | 15 to 35 | 20 to 32 | 20 to 32 |
| monoethanolamine | | | | |
| Water | <10 | <6 | <6 | <2 |
| Misc. | <10 | <6 | <6 | <2 |

| | Formula 31 | Formula 32 | Formula 33 | Formula 34 |
|---|---|---|---|---|
| Total surfactant | 50 to 80 | 50 to 80 | 50 to 80 | 50 to 80 |
| Anionic surfactant | 40 to 65 | 40 to 65 | 45 to 60 | 45 to 60 |
| Alkyl ether sulfonic | 35 to 60 | 35 to 60 | 41 to 54 | 41 to 54 |
| acid | | | | |
| Fatty acid | 1 to 8 | 1 to 8 | 2 to 6 | 2 to 6 |
| Non-ionic surfactant | 12 to 40 | 12 to 40 | 15 to 30 | 15 to 30 |
| Water | <10 | <6 | <6 | <2 |
| Misc. | up to 100 | up to 100 | up to 100 | up to 100 |

| | Formula 36 | Formula 37 | Formula 38 | Formula 39 |
|---|---|---|---|---|
| Total surfactant | 50 to 80 | 50 to 80 | 50 to 80 | 50 to 80 |
| Anionic surfactant | 40 to 65 | 40 to 65 | 45 to 60 | 45 to 60 |
| Alkyl ether sulfonic | 35 to 60 | 35 to 60 | 41 to 54 | 41 to 54 |
| acid | | | | |
| Fatty acid | 1 to 8 | 1 to 8 | 2 to 6 | 2 to 6 |
| Non-ionic surfactant | 12 to 40 | 12 to 40 | 15 to 30 | 15 to 30 |
| Organic amine, preferably | 12 to 38 | 15 to 35 | 20 to 32 | 20 to 32 |
| monoethanolamine | | | | |
| Water | <10 | <6 | <6 | <2 |
| Misc. | up to 100 | up to 100 | up to 100 | up to 100 |
| | Formula 41 | Formula 42 | Formula 43 | Formula 44 |
| Total surfactant | 50 to 80 | 50 to 80 | 50 to 80 | 50 to 80 |
| Anionic surfactant | 40 to 65 | 40 to 65 | 45 to 60 | 45 to 60 |
| Alkyl ether sulfonic | 35 to 60 | 35 to 60 | 41 to 54 | 41 to 54 |
| acid | | | | |
| Fatty acid | 1 to 8 | 1 to 8 | 2 to 6 | 2 to 6 |
| Non-ionic surfactant | 12 to 40 | 12 to 40 | 15 to 30 | 15 to 30 |
| Organic amine, preferably | 12 to 38 | 15 to 35 | 20 to 32 | 20 to 32 |
| monoethanolamine | | | | |
| Water | <10 | <6 | <6 | <2 |
| Misc. | <10 | <6 | <6 | <2 |

| | Formula 46 | Formula 47 | Formula 48 | Formula 49 |
|---|---|---|---|---|
| Total surfactant | 50 to 80 | 50 to 80 | 50 to 80 | 50 to 80 |
| Anionic surfactant | 40 to 65 | 40 to 65 | 45 to 60 | 45 to 60 |
| C₈₋₁₈ alkylbenzene- | 30 to 45 | 30 to 45 | 34 to 42 | 34 to 42 |
| sulfonic acid | | | | |
| Alkyl ether sulfonic | 5 to 15 | 5 to 15 | 7 to 12 | 7 to 12 |
| acid | | | | |
| Fatty acid | 1 to 8 | 1 to 8 | 2 to 6 | 2 to 6 |
| Non-ionic surfactant | 12 to 40 | 12 to 40 | 15 to 30 | 15 to 30 |
| Water | <10 | <6 | <6 | <2 |
| Misc. | up to 100 | up to 100 | up to 100 | up to 100 |

| | Formula 51 | Formula 52 | Formula 53 | Formula 54 |
|---|---|---|---|---|
| Total surfactant | 50 to 80 | 50 to 80 | 50 to 80 | 50 to 80 |
| Anionic surfactant | 40 to 65 | 40 to 65 | 45 to 60 | 45 to 60 |
| C₈₋₁₈ alkylbenzene- | 30 to 45 | 30 to 45 | 34 to 42 | 34 to 42 |
| sulfonic acid | | | | |
| Alkyl ether sulfonic | 5 to 15 | 5 to 15 | 7 to 12 | 7 to 12 |
| acid | | | | |
| Fatty acid | 1 to 8 | 1 to 8 | 2 to 6 | 2 to 6 |
| Non-ionic surfactant | 12 to 40 | 12 to 40 | 15 to 30 | 15 to 30 |
| Organic amine, preferably | 12 to 38 | 15 to 35 | 20 to 32 | 20 to 32 |
| monoethanolamine | | | | |
| Water | <10 | <6 | <6 | <2 |
| Misc. | up to 100 | up to 100 | up to 100 | up to 100 |
| | Formula 56 | Formula 57 | Formula 58 | Formula 59 |
| Total surfactant | 50 to 80 | 50 to 80 | 50 to 80 | 50 to 80 |
| Anionic surfactant | 40 to 65 | 40 to 65 | 45 to 60 | 45 to 60 |
| C₈₋₁₈ alkylbenzene- | 30 to 45 | 30 to 45 | 34 to 42 | 34 to 42 |
| sulfonic acid | | | | |
| Alkyl ether sulfonic | 5 to 15 | 5 to 15 | 7 to 12 | 7 to 12 |
| acid | | | | |
| Fatty acid | 1 to 8 | 1 to 8 | 2 to 6 | 2 to 6 |
| Non-ionic surfactant | 12 to 40 | 12 to 40 | 15 to 30 | 15 to 30 |
| Organic amine, preferably | 12 to 38 | 15 to 35 | 20 to 32 | 20 to 32 |
| monoethanolamine | | | | |
| Water | <10 | <6 | <6 | <2 |
| Misc. | <10 | <6 | <6 | <2 |

Preferred surfactant concentrates do not contain enzyme.

Preferred surfactant concentrates also do not contain any washing-active or cleaning-active polymer.

Preferred surfactant concentrates do not contain any cationic surfactant.

In step d), a surfactant-containing detergent composition is obtained by diluting the surfactant concentrate. The dilution of the surfactant concentrate preferably takes place in the interior, i.e., inside the washing machine housing. Since the surfactant-containing composition provided in step d) is introduced into the laundry treatment chamber in the subsequent step e), the dilution necessarily takes place outside the laundry treatment chamber of the washing machine, for example in a pipe connecting the storage container for the surfactant concentrate to the laundry treatment chamber, or in a mixing device.

In step d), the surfactant concentrate is preferably dosed by means of a dosing device integrated into the washing machine from a container integrated into the washing machine which is filled with several times the amount of surfactant concentrate required to carry out a washing program.

The surfactant concentrate is preferably dosed in step d) at a shear rate above 10 s-1, preferably above 200 s-1 and in particular above 400 s-1. The dosing rate is preferably 0.1 g/s to 10 g/s, preferably 0.5 g/s to 8 g/s. Both the preferred shear and the preferred dosing rate have proven advantageous for rapid and homogeneous dilution.

The surfactant-containing detergent composition can be obtained in step d), for example by diluting the surfactant concentrate with water. As in the case of dosing, it is also preferred during the dilution to work at a shear rate above 10 s-1, preferably above 200 s-1 and in particular above 400 s-1.

In a preferred embodiment, in step d), the surfactant-containing detergent composition is preferably obtained by diluting the surfactant concentrate with an aqueous composition. An aqueous composition contains, in addition to water, at least one washing-active or cleaning-active ingredient. The composition used to dilute the surfactant concentrate preferably does not contain any fabric-softening-active compounds.

In step d), the surfactant concentrate is preferably at least partially diluted by means of a composition taken from a container integrated into the washing machine which is filled with several times the amount of this composition required to carry out a washing program.

In a preferred embodiment, in step d), the surfactant-containing detergent composition is obtained by diluting the surfactant concentrate with an acid-containing aqueous composition. Organic acids, in particular organic acids from the group of citric acid, succinic acid, glutaric acid, adipic acid, gluconic acid, methylglycinediacetic acid, glutamic acid, diacetic acid and copolymeric polysulfonates, are particularly suitable as acids in the acid-containing aqueous composition.

The surfactant concentrate is particularly preferably diluted with a citric acid-containing aqueous composition selected from the citric acid group.

It is also preferred to dilute the surfactant concentrate with an acid-containing aqueous composition, the acid of which is selected from the group of copolymeric polysulfonates, in particular copolymeric polysulfonates which, in addition to monomer(s) containing sulfonic acid groups, contain at least one monomer from the group of unsaturated carboxylic acids, in particular acrylic acid.

Finally, it is very particularly preferred to use, as the acid of the acid-containing aqueous composition, an organic peracid, preferably a peroxycarboxylic acid, in particular a peroxycarboxylic acid from the group of
i) mono- and diperoxycarboxylic acids, such as performic acid, peracetic acid, decanedioic acid, dodecanedioic acid,
ii) mono- and diperphthalic acids,
iii) mono- and diperterephthalic acids,
iv) imidoperoxycarboxylic acids. such as 6-phthalimidoperoxycaproic acid (PAP). The use of 6-phthalimidoperoxycaproic acid (PAP) is very particularly preferred.

If the surfactant concentrate contains an excess of alkaline components, for example an excess of an organic amine, the dilution in step d) is accompanied by a neutralization reaction when an acid-containing aqueous composition is used. This neutralization reaction is suitable for accelerating the dilution process. When selecting the above-mentioned acids, the resulting surfactant-containing composition is also enriched with a washing-active ingredient, for example a complexing agent or an oxygen bleach.

For rapid and homogeneous dilution, it has proven advantageous if, in step d), the surfactant-containing detergent composition is obtained by diluting the surfactant concentrate with a composition, the temperature of which is more than 15° C., preferably more than 25° C. and in particular more than 30° C.

In step d), the surfactant concentrate is preferably diluted by a factor of between 5 and 50.

In order to monitor and control the dilution taking place in step d) and to monitor and control any reactions associated with the dilution, the surfactant-containing composition can be analyzed in step d). Suitable analysis parameters include, for example, the pH, turbidity, conductivity or temperature of the surfactant-containing composition.

In step e) of the method, the surfactant-containing composition is introduced into the laundry treatment chamber of the washing machine.

The surfactant-containing composition introduced into the laundry treatment chamber of the washing machine in step e) preferably contains no enzyme and/or no washing-active or cleaning-active polymer and/or no fabric-softening-active compound.

To achieve the desired cleaning effect, it has proven advantageous to add the composition to the washing liquor over a short period. Preferred washing methods are therefore characterized in that, in step e), the surfactant-containing composition is introduced into the laundry treatment chamber of the washing machine over a period of less than five minutes, preferably over a period of less than two minutes and in particular over a period of less than one minute.

In comparison to conventional washing methods, the washing-active or cleaning-active ingredients in the method according to the invention are introduced into the laundry treatment room in pre-dissolved or completely dissolved form and immediately reach their maximum effective concentration.

This application provides, inter alia, the following subjects:
1. A method for washing textiles in a washing machine which has a laundry treatment chamber and a storage container for a surfactant concentrate, having the steps of
   a) providing a washing machine with a wash program;
   b) introducing textiles into the laundry treatment chamber of the washing machine;
   c) introducing an aqueous liquor into the laundry treatment chamber of the washing machine;
   d) providing a surfactant-containing detergent composition by diluting a surfactant concentrate which contains, relative to the total weight thereof,
      i) 50 to 95 wt. % surfactant;
      ii) less than 10 wt. % water;
   e) introducing the surfactant-containing detergent composition into the laundry treatment chamber of the washing machine.
2. The washing method according to point 1, wherein the surfactant concentrate contains, relative to the total weight thereof, 55 to 92 wt. %, preferably 60 to 88 wt. % and in particular 68 to 80 wt. %, surfactant.
3. The washing method according to one of the preceding points, wherein the surfactant concentrate contains anionic surfactant from the group from the group of C₈₋₁₈ alkylbenzenesulfonic acids.
4. The washing method according to one of the preceding points, wherein the surfactant concentrate contains anionic surfactant from the group from the group of alkyl ether sulfonic acids.
5. The washing method according to one of the preceding points, wherein the surfactant concentrate contains anionic surfactant from the group from the group of fatty acids.
6. The washing method according to one of the preceding points, wherein the surfactant concentrate contains, relative to the total weight thereof, 30 to 90 wt. %, preferably 40 to 80 wt. %, in particular 45 to 70 wt. % and very particularly preferably 51 to 70 wt. %, anionic surfactant.
7. The washing method according to one of the preceding points, wherein the surfactant concentrate contains C₈₋₁₈ alkylbenzenesulfonic acid and alkyl ether sulfonic acid as anionic surfactant, the C₈₋₁₈ alkylbenzenesulfonic acid and the alkyl ether sulfonic acid being present in a weight ratio of 10:1 to 1:1, preferably 7:1 to 2:1 and in particular 5:1 to 5:2.
8. The washing method according to one of the preceding points, wherein the surfactant concentrate contains C₈₋₁₈ alkylbenzenesulfonic acid and fatty acid as anionic surfactant, the C₈₋₁₈ alkylbenzenesulfonic acid and the fatty acid being present in a weight ratio of 20:1 to 6:1, preferably 18:1 to 6:1 and in particular 15:1 to 8:1.
9. The washing method according to one of the preceding points, wherein the surfactant concentrate contains alkyl ether sulfonic acid and fatty acid as anionic surfactant, the alkyl ether sulfonic acid and the fatty acid being present in a weight ratio of 6:1 to 1:1, preferably 5:1 to 3:2 and in particular 4:1 to 2:1.
10. The washing method according to one of the preceding points, wherein the surfactant concentrate contains nonionic surfactant from the group of ethoxylated primary C6-18 alcohols, preferably the ethoxylated primary C6-18 alcohols having a degree of alkoxylation ≥2, particularly preferably the C12-14 alcohols having 4 EO or 7 EO, the C9-11 alcohols having 7 EO, the C13-15 alcohols having 5 EO, 7 EO or 8 EO, the C13-15 oxo alcohols having 7 EO, the C12-18 alcohols having 5 EO or 7 EO, in particular the C12-18 fatty alcohols having 7 EO or the C13-15 oxo alcohols having 7 EO.
11. The washing method according to one of the preceding points, wherein the surfactant concentrate contains, relative to the total weight thereof, 7 to 50 wt. %, preferably 12 to 40 wt. % and in particular 15 to 30 wt. %, nonionic surfactant.
12. The washing method according to one of the preceding points, wherein the weight ratio of anionic surfactant to nonionic surfactant is 4:1 to 1:8, preferably 3:1 to 1:4, and in particular 11:4 to 1:1.
13. The washing method according to one of the preceding points, wherein the surfactant concentrate contains, relative to the total weight thereof, polyalkoxylated amine having a weight-average molecular weight Mw in the range from 600 g/mol to 10,000 g/mol, which is obtained by reacting ammonia or primary alkylamines or hydroxyalkylamines having a molecular weight of less than 200 g/mol with alkylene oxides, preferably in proportions by weight of 0.5 to 10 wt. %, preferably 1 to 8 wt. %, and in particular 2 to 6 wt. %.
14. The washing method according to one of the preceding points, wherein the surfactant concentrate contains, relative to the total weight thereof, polyalkoxylated polyalkyleneimine, which is obtained by reacting polyalkyleneimines with alkylene oxides, preferably in proportions by weight of 0.5 to 10 wt. %, preferably 1 to 8 wt. %, and in particular 2 to 6 wt. %.
15. The washing method according to one of the preceding points, wherein the surfactant concentrate contains, relative to the total weight thereof, 12 to 36 wt. %, preferably 18 to 34 wt. % and in particular 24 to 32 wt. %, solvent.
16. The washing method according to one of the preceding points, wherein the surfactant concentrate contains, relative to the total weight thereof, less than 8 wt. %, preferably less than 6 wt. %, and in particular less than 2 wt. %, water.
17. The washing method according to one of the preceding points, wherein the surfactant concentrate contains, relative to the total weight thereof, 0.5 to 29 wt. %, preferably 4.5 to 27 wt. % and in particular 10 to 24 wt. %, organic solvent.
18. The washing method according to one of the preceding points, wherein the surfactant concentrate contains, relative to the total weight thereof, 12 to 38 wt. %, preferably 15 to 35 wt. % and in particular 20 to 32 wt. %, organic solvent.
19. The washing method according to one of the preceding points, wherein the surfactant concentrate contains solvent from the group of organic amines, preferably monoethanolamine.
20. The washing method according to one of the preceding points, wherein the surfactant concentrate comprises anionic surfactant from the group of C₈₋₁₈ alkylbenzenesulfonic acids, alkyl ether sulfonic acids and fatty acids, and also a superstoichiometric amount, relative to the anionic surfactant, of organic amine, preferably monoethanolamine.
21. The washing method according to one of the preceding points, wherein the surfactant concentrate contains, relative to the total weight thereof, less than 12 wt. %, preferably less than 8 wt. %, particularly preferably less than 4 wt. % and in particular less than 1 wt. % organic solvent from the group of monohydric, dihydric or trihydric alcohols having a molecular weight of 30 to 120 g/mol.
22. The washing method according to one of the preceding points, wherein the surfactant concentrate contains, relative to the total weight thereof, less than 12 wt. %, preferably less than 8 wt. %, particularly preferably less than 4 wt. % and in particular less than 1 wt. % organic solvent from the group of ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxybutanol, propylene glycol t-butylether, di-n-octylether and mixtures thereof, preferably from the group of propanediol, glycerol and mixtures thereof.
23. The washing method according to one of the preceding points, wherein the surfactant concentrate contains, relative to the total weight thereof.
   i) 30 to 90 wt. %, preferably 40 to 80 wt. %, and in particular 45 to 70 wt. % anionic surfactant from the group of C₈₋₁₈ alkylbenzenesulfonic acids, alkyl ether sulfonic acids and fatty acids,
   ii) 7 to 50 wt. %, preferably 12 to 40 wt. %, and in particular 15 to 30 wt. % nonionic surfactant from the group of ethoxylated primary C6-18 alcohols,
   iii) 0.5 to 29 wt. %, preferably 4.5 to 27 wt. % and in particular 10 to 24 wt. % organic solvent from the group of organic amines,
   iv) less than 10 wt. %, preferably less than 6 wt. % and in particular less than 2 wt. % water.
24. The washing method according to one of the preceding points, wherein the surfactant concentrate contains, relative to the total weight thereof,
   v) 30 to 80 wt. %, preferably 40 to 70 wt. %, and in particular 45 to 60 wt. % anionic surfactant from the group of C₈₋₁₈ alkylbenzenesulfonic acids, alkyl ether sulfonic acids and fatty acids,
   vi) 7 to 50 wt. %, preferably 12 to 40 wt. %, and in particular 15 to 30 wt. % nonionic surfactant from the group of ethoxylated primary C6-18 alcohols,
   vii) 12 to 38 wt. %, preferably 15 to 35 wt. % and in particular 20 to 32 wt. % organic solvent from the group of organic amines,
   viii) less than 10 wt. %, preferably less than 6 wt. % and in particular less than 2 wt. % water.
25. The washing method according to one of the preceding points, wherein the surfactant concentrate contains, relative to the total weight thereof,
   v) 30 to 80 wt. %, preferably 40 to 70 wt. %, and in particular 45 to 60 wt. % anionic surfactant in the form of a mixture of C₈₋₁₈ alkylbenzenesulfonic acids, alkyl ether sulfonic acids and fatty acids,
   vi) 7 to 50 wt. %, preferably 12 to 40 wt. %, and in particular 15 to 30 wt. % nonionic surfactant from the group of ethoxylated primary C6-18 alcohols,
   vii) 12 to 38 wt. %, preferably 15 to 35 wt. % and in particular 20 to 32 wt. % organic solvent from the group of organic amines,
   viii) less than 10 wt. %, preferably less than 6 wt. % and in particular less than 2 wt. % water.
26. The washing method according to one of the preceding points, wherein the surfactant concentrate contains no enzyme.
27. The washing method according to one of the preceding points, wherein the surfactant concentrate contains no washing-active or cleaning-active polymer.
28. The washing method according to one of the preceding points, wherein the surfactant concentrate contains no cationic surfactant.
29. The washing method according to one of the preceding points, wherein, in step d), the surfactant concentrate is taken from a container integrated into the washing machine, which is filled with several times the amount of surfactant concentrate required to carry out a washing program.
30. The washing method according to one of the preceding points, wherein, in step d), the surfactant concentrate is preferably dosed by means of a dosing device integrated into the washing machine from a container integrated into the washing machine which is filled with several times the amount of surfactant concentrate required to carry out a washing program.
31. The washing method according to one of the preceding points, wherein, in step d), the surfactant concentrate is dosed at a shear rate above 10 s-1, preferably above 200 s-1 and in particular above 400 s-1.
32. The washing method according to one of the preceding points, wherein, in step d), the surfactant concentrate is dosed at a dosing rate of 0.1 g/s to 10 g/s, preferably 0.5 g/s to 8 g/s.
33. The washing method according to one of the preceding points, wherein the dilution of the surfactant concentrate takes place in the interior of the washing machine.
34. The washing method according to one of the preceding points, wherein, in step d), the surfactant-containing detergent composition is obtained by diluting the surfactant concentrate with water, preferably by diluting the surfactant concentrate with water at a shear rate above 10 s-1, preferably above 200 s-1 and in particular above 400 s-1.
35. The washing method according to one of the preceding points, wherein, in step d), the surfactant-containing detergent composition is obtained by diluting the surfactant concentrate with an aqueous composition.
36. The washing method according to one of the preceding points, wherein, in step d), the surfactant concentrate is at least partially diluted by means of a composition taken from a container integrated into the washing machine which is filled with several times the amount of this composition required to carry out a washing program.
37. The washing method according to one of the preceding points, wherein, in step d), the surfactant-containing detergent composition is obtained by diluting the surfactant concentrate with a composition that does not contain any fabric-softening-active compounds.
38. The washing method according to one of the preceding points, wherein, in step d), the surfactant-containing detergent composition is obtained by diluting the surfactant concentrate with an acid-containing aqueous composition.
39. The washing method according to point 38, wherein the acid of the acid-containing aqueous composition is selected from the group of organic acids, in particular organic acids from the group of citric acid, succinic acid, glutaric acid, adipic acid, gluconic acid, methylglycinediacetic acid, glutamic acid, diacetic acid and the copolymeric polysulfonates.
40. The washing method according to point 38, wherein the acid of the acid-containing aqueous composition is selected from the citric acid group.
41. The washing method according to point 38, wherein the acid of the acid-containing aqueous composition is selected from the group of copolymeric polysulfonates, in particular copolymeric polysulfonates which, in addition to monomer(s) containing sulfonic acid groups, contain at least one monomer from the group of unsaturated carboxylic acids, in particular acrylic acid.
42. The washing method according to point 38, wherein the acid of the acid-containing aqueous composition is selected from the group of organic peracids, preferably peroxycarboxylic acids, in particular peroxycarboxylic acids from the group of
   i) mono- and diperoxycarboxylic acids, such as performic acid, peracetic acid, decanedioic acid, dodecanedioic acid,
   ii) mono- and diperphthalic acids,
   iii) mono- and diperterephthalic acids,
   iv) imidoperoxycarboxylic acids, such as 6-phthalimidoperoxycaproic acid (PAP).
43. The washing method according to point 38, wherein the acid of the acid-containing aqueous composition is selected from the 6-phthalimidoperoxycaproic acid (PAP) group.
44. The washing method according to one of the preceding points, wherein, in step d), the surfactant-containing detergent composition is obtained by diluting the surfactant concentrate with a composition, the temperature of which is more than 15° C., preferably more than 25° C. and in particular more than 30° C.
45. The washing method according to one of the preceding points, wherein, in step d), the surfactant-containing detergent composition is obtained by diluting the surfactant concentrate by a factor of greater than 3, preferably by diluting the surfactant concentrate by a factor of between 5 and 50.
46. The washing method according to one of the preceding points, wherein the surfactant-containing composition is analyzed in step d).
47. The washing method according to point 46, wherein the pH of the surfactant-containing composition is analyzed in step d).
48. The washing method according to point 46 or 47, wherein the turbidity of the surfactant-containing composition is analyzed in step d).
49. The washing method according to point 46 to 48, wherein the conductivity of the surfactant-containing composition is analyzed in step d).
50. The washing method according to point 46 to 49, wherein the temperature of the surfactant-containing composition is analyzed in step d).
51. The washing method according to one of the preceding points, wherein the surfactant-containing composition introduced into the laundry treatment chamber of the washing machine in step e) contains no enzyme and/or no washing-active or cleaning-active polymer and/or no fabric-softening-active compound.
52. The washing method according to one of the preceding points, wherein, in step e), the surfactant-containing composition is introduced into the laundry treatment chamber of the washing machine over a period of less than five minutes, preferably over a period of less than two minutes and in particular over a period of less than one minute.

1. A method for washing textiles in a washing machine, the washing machine having a laundry treatment chamber and a storage container configured to store a surfactant concentrate, the method comprising:
providing a wash program to the washing machine;
introducing the textiles into the laundry treatment chamber;
introducing an aqueous liquor into the laundry treatment chamber;
diluting the surfactant concentrate comprising a surfactant in an amount of from 50 to 95 wt. % based on the total weight of the surfactant concentrate and water in an amount less than 10 wt. % based on the total weight of the surfactant concentrate to produce a surfactant-containing detergent composition; and
introducing the surfactant-containing detergent composition into the laundry treatment chamber.

2. The method of claim 1, wherein the surfactant is in an amount of from 55 to 92 wt. % based on the total weight of the surfactant concentrate.

3. The method of claim 1, wherein the surfactant comprises an anionic surfactant selected from the group consisting of C₈₋₁₈ alkylbenzenesulfonic acids.

4. The method of claim 1, wherein the surfactant comprises an anionic surfactant selected from the group consisting of alkyl ether sulfonic acids.

5. The method of claim 1, wherein the surfactant comprises an anionic surfactant selected from the group consisting of fatty acids.

6. The method of claim 1, wherein the surfactant comprises an anionic surfactant in an amount of from 30 to 90 wt. % based on the total weight of the surfactant concentrate.

7. The method of claim 1, wherein the surfactant comprises a nonionic surfactant selected from the group consisting of ethoxylated primary C6-18 alcohols.

8. The method of claim 1, wherein the surfactant comprises a nonionic surfactant in an amount of from 7 to 50 wt. % based on the total weight of the surfactant concentrate.

9. The method of claim 1, wherein the water is in an amount less than 6 wt. % based on the total weight of the surfactant concentrate.

10. The method of claim 1, wherein the surfactant comprises an organic solvent in an amount of from 0.5 to 29 wt. % based on the total weight of the surfactant concentrate.

11. The method of claim 2, wherein the surfactant is in an amount of from 60 to 88 wt. % based on the total weight of the surfactant concentrate.

12. The method of claim 6, wherein the anionic surfactant is in an amount of from 45 to 70 wt. % based on the total weight of the surfactant concentrate.

13. The method of claim 7, wherein the ethoxylated primary C6-18 alcohols have a degree of alkoxylation ≥2.

14. The method of claim 13, wherein the ethoxylated primary C6-18 alcohols are selected from the group consisting of:
C12-14 alcohols having 4 EO or 7 EO,
C9-11 alcohols having 7 EO,
C13-15 alcohols having 5 EO, 7 EO or 8 EO,
C13-15 oxo alcohols having 7 EO,
C12-18 alcohols having 5 EO or 7 EO, and
C13-15 oxo alcohols having 7 EO.

15. The method of claim 8, wherein the nonionic surfactant is in an amount of from 15 to 30 wt. % based on the total weight of the surfactant concentrate.

16. The method of claim 9, wherein the water is in an amount less than 2 wt. % based on the total weight of the surfactant concentrate.

17. The method of claim 10, wherein the organic solvent is in an amount of from 10 to 24 wt. % based on the total weight of the surfactant concentrate.

18. The method of claim 10, wherein the organic solvent is selected from the group consisting of organic amines.

19. The method of claim 18, wherein the organic solvent is monoethanolamine.

20. The method of claim 1, wherein the surfactant comprises an anionic surfactant and a nonionic surfactant, and wherein the weight ratio of the anionic surfactant to the nonionic surfactant is from 4:1 to 1:8.
